(19) United States
(12) Patent Application Publication
(10) Pub. No.: US 2017/0011814 A1
(43) Pub. Date: Jan. 12, 2017

(54) Method and Apparatus for Assessing and Diluting Contaminated Radioactive Materials

(71) Applicant: Leong Ying, Hoboken, NJ (US)

(72) Inventor: Leong Ying, Hoboken, NJ (US)

(21) Appl. No.: 14/816,554

(22) Filed: Aug. 3, 2015

Related U.S. Application Data
(60) Provisional application No. 62/190,513, filed on Jul. 9, 2015.

(51) Int. Cl. G21F 9/00; G01T 1/167

(52) U.S. Cl. CPC G21F 9/008; G01T 1/167

(57) ABSTRACT

A method and an apparatus for its practice to render radioactive earth materials such as NORM and TENORM more suitable for disposal, includes detecting the level of radioactivity in such earth materials as well as detecting the specific energy of radiation to identify specific isotopes within the earth materials. The radioactive earth materials are diluted with appropriate materials suitable for disposal. Preferably, the radioactivity of the diluted material is monitored to assure the resulting mixture is suitable for the disposal intended.

### CROSS REFERENCE TO RELATED APPLICATIONS

This application is based on provisional application Ser. No. 62/190,513 filed Jul. 9, 2015.

### FIELD OF THE INVENTION

The present invention relates to a method and apparatus for assessing and diluting contaminated radioactive materials in earth samples of the type that may result from hydraulic fracturing (“fracking”) in order to “down-blend” for proper disposal.

### BACKGROUND OF THE INVENTION

Proposals have been made to dilute or down-blend contaminated materials to render them safer for use or disposal. U.S. Pat. No. 5,597,399 describes producing a soil enhancing compound by mechanically mixing a portion of composted agricultural waste with a portion of bio-solid waste to form an organic compost mixture. In one example, radioactive phosphogypsum, a waste product from production of phosphate fertilizers, is used as a blending agent. If the radioactivity of the industrial waste exceeds permissible levels, the proportions of the other components in the final compound can be increased to dilute the radioactivity of the soil enhancing compound to acceptable levels. U.S. Pat. No. 5,411,722 relates to converting uranium metal to uranium oxide in a reaction cell by down-blending highly enriched uranium metal by the simultaneous conversion of highly enriched uranium metal and natural or depleted uranium metal to uranium oxide within the reaction cell.

U.S. Pat. No. 3,332,884 describes mixing coal waste slag with radioactive materials from nuclear reactors to enhance disposal.

Often, radioactive materials from underground are brought to the surface by various activities such as hydraulic fracturing (fracking) operations that bring to the surface undesired Naturally Occurring Radioactive Material (NORM) along with the desired oil and natural gas. Federal and various State regulations require radioactive testing of soil at sites in which such development and processing occurs, and the Federal Environmental Protection Agency has set out compliance rules in their report EPA 530-R-01-007 Land Disposal Restrictions.

Current disposal methods for contaminated earth materials are often at landfill sites, but highly radioactive contaminated wastes may trigger certain detection portals positioned at the entrance to the landfill sites, leading to rejection of such wastes. Such highly radioactive contaminated wastes that may not be suitable for disposal in landfills may be injected back into the deeply drilled wells where local regulations allow, or may need to be transported far afield to specific sites licensed to handle and dispose of contaminated wastes of higher radiation level.

Uranium-238 and Thorium-232 are NORM that have decay half-lives of billions of years, and once they are brought up to the surface through human activities, they are classified as Technologically Enhanced Naturally Occurring Radioactive Material (TENORM) and can remain an environmental and health concern for an indefinite time if not properly identified and disposed.

To compound the problems, various radioisotopes within the natural decay chains have different solubility and diffusion properties, resulting in the possibility some isotopes may escape from the radioactive medium through water leaching or gaseous release into the atmosphere. Of major concerns are soluble isotopes Ra226 and Ra228, which are also the precursors to gaseous radon. An important feature of the present invention, therefore, is to not merely quantify the radioactive levels of NORM and TENORM, but also ideally identify the isotopes in the contaminated wastes in order to evaluate fully the nature of the contamination and determine properly how best to defuse the potential hazard.

It is, therefore, an object of the present invention to provide a method and apparatus for evaluating NORM and TENORM to assess the potential hazard, and then render the materials safe for proper disposal.

### SUMMARY OF THE INVENTION

To this end, in order to render radioactive earth materials such as NORM and TENORM more suitable for disposal, the level of radioactivity in such earth materials is detected as well as detecting the specific energy of radiation to identify specific isotopes within the earth materials, and diluting the earth materials with appropriate materials suitable for disposal. Preferably, the radioactivity of the diluted material is monitored to assure the resulting mixture is suitable for the disposal intended.

The materials used for the down blending process are uncontaminated or minimally contaminated materials that have preferably been analyzed for their radioactive properties to enable a more inert mixture for safer handling and dispersal be produced in a controlled manner. After being mixed with the radioactive earth materials, the resulting mixture may be further analyzed to determine the level of radioactive contamination in the resulting mixture before release.

These and other objects, advantages and features of the present invention will become apparent from the description given below, which is made in conjunction with the following drawing figures:

### BRIEF DESCRIPTION OF THE DRAWINGS

FIG. 1 illustrates a flowchart of the process and schematic of an apparatus that can be used for the practice of the present invention;

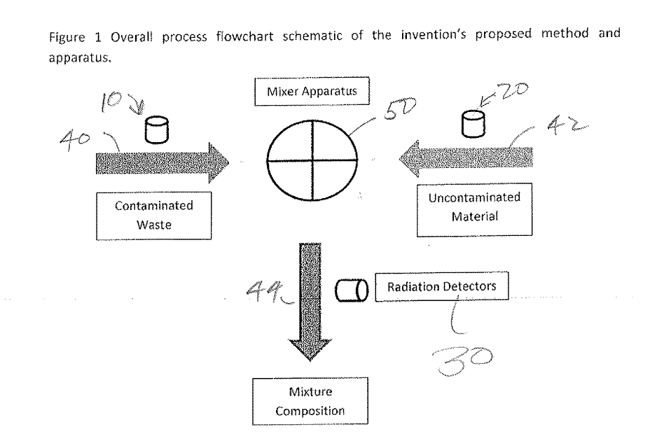

FIG. 2 illustrates the decay chains of Uranium-238 and Thorium-232 that typically make up a portion of the Naturally Occurring Radioactive Material (NORM) found in earth samples;

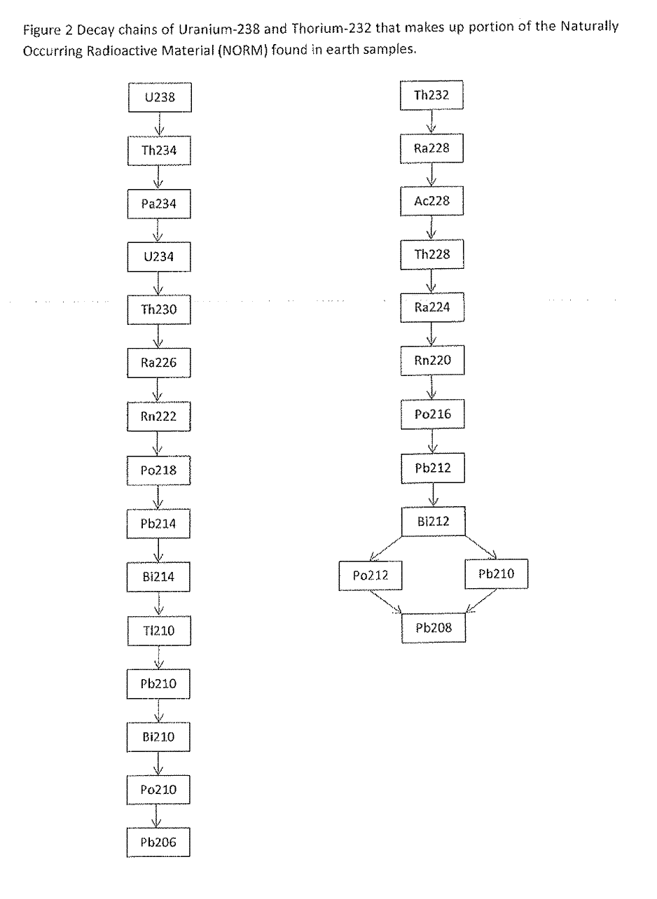

FIG. 3 illustrates the counts in an identified energy peak as part of the gamma detection spectrum of the present invention;

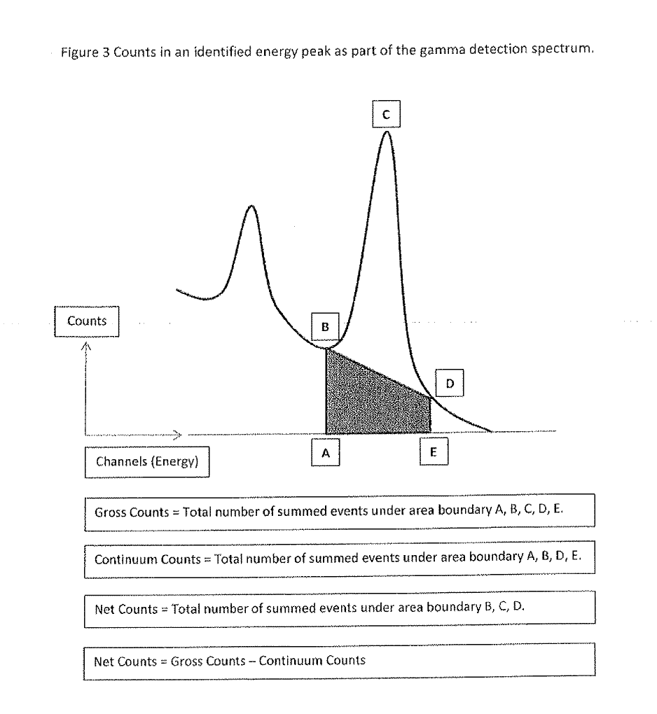

FIG. 4 is a schematic for a detection system for assessing and identifying the radioactivity of the earth samples and mixture concentration according to the present invention.

### DETAILED DESCRIPTION OF AN EMBODIMENT

As set forth below, the present invention provides a method for assessing and identifying the radioactivity of earth samples, and an apparatus for mechanical mixing contaminated samples with materials to produce a more inert compounded mixture.

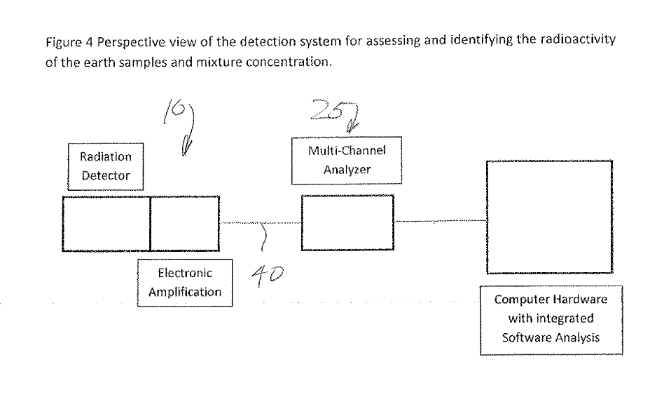

A detection system 10 according to the present invention includes a sodium iodide (NaI) scintillation detector coupled to a photomultiplier Tube (PMT,) as is known in the art. An alternative arrangement for the detection system 10 could be a high-purity germanium (HPGe) semiconductor radiation detector coupled to a preamplifier. The outputs from the detection system 10 are preferably channeled through a multi-channel analyzer (MCA,) as shown at 25 in FIG. 4, that by spectroscopy electronically places each count into channels that are directly proportional to the energy of the incident gamma-ray radiation. The identification of specific gamma emitting isotopes by their unique decay signatures can thus be determined.

To improve the sensitivity of the instrument by reducing background noise, the detector and sample chamber of the multi-channel analyzer may be shielded with materials such as lead or tungsten. To complement the detection system to also detect alpha and beta radiation, thin-windowed detectors such as Geiger-Muller tubes can also be integrated.

Through appropriate gamma spectroscopy, the identity of specific radioactive isotopes can be determined in the contaminated earth wastes by the detection system 10. If the wastes have been processed, then it is even more critical to identify the isotopes since the contaminated composition of the processed materials can vary considerably depending on the type of processing. The same analysis can be performed on uncontaminated materials by the detection system 20 to assess the quality prior to mixing with the contaminated wastes. The detection system 20 similarly to the detection system 10 includes a sodium iodide (NaI) scintillation detector coupled to a photomultiplier Tube (PMT) or the alternative of a high-purity germanium (HPGe) semiconductor radiation detector coupled to a preamplifier. The final mixture will also need to be properly analyzed by detection system 30 to ensure it meets regulatory limits for transportation and disposal. Detection system 30 is comparable to detection systems 10 and 20.

Along with identifying the specific isotopes, it is also important to characterize the radioactive concentration in the waste medium by the detection system 30. Hence, the total number of detected gamma-rays in a known time unit selected for measurement, and the concentration of the tested sample must also be determined. The measurement time is a simple quantifiable parameter to be set.

The level of radioactivity of solid wastes is defined per concentration of mass, in typical units of Becquerel per kilogram (Bq/kg) or pico-Curie per gram (pCi/g). One Becquerel is a radioactive decay per second, and one Curie is 3.7×10¹⁰ decays per second. A count is defined as an instance of decay and associated with the detection of the emitted gamma-ray. The simplest method of determining the concentration of the tested samples is to weigh the sample in the appropriate units of grams or kilograms.

The total gamma counts for an identified isotope can be quantified by summing the number of events within the peak identified in the gamma spectrum associated with the isotope of interest. For example, for Ra226 the number of counts can be determined within the identified 186 keV energy peak in the gamma spectrum. For Ra228, the decay daughter Ac228 has three closely associated peaks at 911 keV, 965 keV and 969 keV. Using high-resolution HPGe detector it is possible to differentiate these three Ac228 peaks, but not with a low-resolution NaI detector. However, it is still possible to quantify the radioactivity by summing all the overlapping peaks, by prior calibration of the system with known standard source typically traceable to National Institute of Standards and Technology (NIST) or a similarly recognized laboratory supplied standard which the detection system can be prior calibrated against.

The total counts summed within a peak of interest will likely include counts from background events that are not directly associated with the true radioactivity of the isotope of interest. This background noise could contribute a systematic error to the measurement uncertainty. To reduce this uncertainty, the background levels can be reduced by shielding the system including the tested samples with a dense shield such as lead or tungsten.

Software algorithm can also be used to compute the background counts, also referred to as the Continuum that lies beneath the true activity counts inside the peak of interest. By subtracting this Continuum counts from the gross total counts within the peak, the true radioactivity counts referred to as the net counts can be determined with lower associated uncertainties.

By determining the radioactivity concentration (R in units of Bq/kg) of the contaminated wastes (Rwaste) and uncontaminated materials (Rmaterial), the mixture activity (Rmixture) by combining contaminated wastes of mass (Mwaste) (in units of kilogram) and uncontaminated material of mass (Mmaterial) can be estimated by the following equation:

Rmixture=(Rwaste·Mwaste+Rmaterial·Mmaterial)/(Mwaste+Mmaterial)

The final mixture radioactivity concentration (Rmixture) can be physically measured by detection system 30 to determine if it is below the required regulatory limits before release for transportation and disposal.

Uncontaminated materials to be used can consist of earth compositions such as soil, bio-mass and any manmade materials permissible for disposals at landfill sites. For large scale industrial processing where contaminated wastes and uncontaminated materials are continuously fed by conveyor belts or the like as shown schematically at 40, 42 and 44 into a mixture apparatus 50 for mechanical mixing, it may be an advantage to place large area detectors such as plastic scintillators in close proximity to the moving materials to determine the gross radioactivity counts. The large area increases the detection sensitivity of the system thereby reducing the required time of measurement. However, gross radioactivity does not typically convey specific identification of isotopes. But by appropriate cross-calibrations and material-characterization it is possible to infer the volumetric radioactivity concentrations Rwaste/material/mixture to the gross area radioactivity counts Awaste/material/mixture through the following equation:

R=C·A

Where C is a constant of cross-calibration of the detection system specific for each type of wastes and materials making up the mixture.

Several methods can be employed to detect and quantify the radiation levels of the waste mixture. By using the known area of the conveying system, the amount of radiation given off from the surface and going into the detector system 30 can be typically measured in units of Rem/hr (or SI units of Sivert/hr). Alternatively, by knowing the volume quantified for a known concentration of mass and typically measured in units of pCi/g (or SI units of Bq/kg).

Typically surface area measurements are easier to conduct inasmuch as the concentration of the test samples need not be known. On a large scale where continuous waste is being transported on a conveyor belt, it is easier and more efficient to measure just the surface area radiation and not take volumetric samples. Hence the detection system 30 for the waste material may be a large surface area radiation detector such as a plastic scintillator close to the surface of the conveyor belt to determine the gross activity in Rem/hr (or more typically in smaller unit of uRem/hr) efficiently.

Inasmuch as regulations on radioactive wastes are typically defined in volumetric concentration in units of pCi/g, the system to determine the correlation between uRem/hr and pCi/g can be easily calculated by software in the detection system 30. By knowing the known mass of the waste mixture and determining the pCi/g value using the NaI crystal scintillation detector, preferably by several sampling and average the value for pCi/g, the resulting waste mixture may be placed on a conveyor belt and run through a plastic scintillation detector to determine the uRem/hr value. Since this is the same tested wastes, a calibration constant can be determined by the formula:

C=R/A in units of pCi·hr/uRem·g

As described above, a system for rendering radioactive wastes of earth materials suitable for disposal includes detection of the radiation level and identity of specific isotopes in the radioactive waste material and mixing it with suitable material to produce a waste product that can be evaluated in place to determine if it meets regulatory requirements for disposal. A specific application of my invention has been described above to set forth a method for performing the present invention and apparatus for the practice of the present invention. Such details as described above, however, are not to be considered limiting the application of the present invention which is defined in the appended claims.

What is claimed is:

1. A method to render radioactive earth materials such as NORM and TENORM more suitable for disposal, including detecting the level of radioactivity of such earth materials and one or more specific energy levels thereof, diluting such earth materials with appropriate materials to produce a mixture suitable for disposal, and monitoring the radioactivity level of said mixture to assure the resulting mixture is suitable for disposal.

2. A method to render radioactive earth materials such as NORM and TENORM more suitable for disposal as set forth in claim 1, including monitoring said appropriate materials to determine their radioactive properties prior to said dilution.

3. A method to render radioactive earth materials such as NORM and TENORM more suitable for disposal as set forth in claim 1, including conveying the materials to be assessed on a surface, and assessing the levels of radioactivity by providing a detection instrument adjacent a known area of said surface, and measuring the amount of radiation given off from the surface.

4. A method to render radioactive earth materials such as NORM and TENORM more suitable for disposal as set forth in claim 3, said conveying materials to be assessed being said mixture for disposal.

5. A method to render radioactive earth materials such as NORM and TENORM more suitable for disposal as set forth in claim 1, determining the volumetric concentration of the mixture to be assessed for disposal over time during said conveying, and determining by sampling the radiation levels of the volumetric concentration of said mixture to determine a calibration constant, and calculating the radiation per volume as a result thereof during said conveying.

6. An apparatus for rendering radioactive earth materials such as NORM and TENORM more suitable for disposal, including a detector able to sense the level of radioactivity of such earth materials and one or more specific energy levels thereof, a mixer apparatus to diluting such earth materials with appropriate materials to produce a mixture suitable for disposal, and a monitor to sense the radioactivity level of said mixture to assure the resulting mixture is suitable for disposal.

7. An apparatus for rendering radioactive earth materials such as NORM and TENORM more suitable for disposal as set forth in claim 6, including a monitor to sense the radioactive properties of said appropriate materials prior to said dilution.

8. An apparatus for rendering radioactive earth materials such as NORM and TENORM more suitable for disposal as set forth in claim 6, including a conveyor having a surface area for the materials to be assessed, and said detector being positioned adjacent a known area of said surface and suitable for measuring the amount of radiation given off from the surface.

9. An apparatus for rendering radioactive earth materials such as NORM and TENORM more suitable for disposal as set forth in claim 8, including a conveyor for said mixture for disposal.

10. An apparatus for rendering radioactive earth materials such as NORM and TENORM more suitable for disposal as set forth in claim 6, a sensor for determining the volumetric concentration over time of the mixture to be assessed for disposal during said conveying to determine by sampling the radiation levels of the volumetric concentration of said mixture and provide a calibration constant, and a calculator device for calculating the radiation per volume as a result thereof during said conveying.
